(19) United States
(12) Patent Application Publication
(10) Pub. No.: US 2008/0021723 A1
(43) Pub. Date: Jan. 24, 2008

(54) SHARED MULTI-TENANT COMMUTING MANAGEMENT

(76) Inventor: Murali Krishna DEVARAKONDA, Santa Clara, CA (US)

Correspondence Address: GLENN PATENT GROUP, 3475 EDISON WAY, SUITE L, MENLO PARK, CA, 94025, US

(21) Appl. No.: 11/782,577

(22) Filed: Jul. 24, 2007

Related U.S. Application Data
(60) Provisional application No. 60/820,221, filed on Jul. 24, 2006.

(51) Int. Cl. G06Q 10/00

(52) U.S. Cl. 705/1

(57) ABSTRACT

Methodologies are executed within the context of a shared multi-tenant hosted system to provide commuting management on demand. Multiple organizations (such as companies, universities, municipal governments, physical sites within larger organizations, sponsoring businesses, etc.) can participate across the hosted system. Individual participants can organize car pools and other commuting activity. Organizations can provide incentives to individual participants for engaging in desired activities, such as participating in carpools or otherwise reducing carbon emissions.

### RELATED APPLICATIONS

This application claims the benefit of U.S. Provisional Application Ser. No. 60/820,221, entitled “Shared Multi-Tenant Commuting Management” and filed on Jul. 24, 2006, the entirety of which is incorporated herein by reference.

### TECHNICAL FIELD

The present invention pertains generally to automatic coordination of multi-tenant commuting and to facilitation of carbon emission reduction solutions.

### BACKGROUND

Many companies would like to provide incentives for their employees to participate in carpools and other commuting related activities. This is true for tax and public relations reasons, as well as a more community spirited desire to reduce carbon-based emissions and other hazards associated with driving.

Additionally, many businesses would be interested in participating in carpooling activity as a pickup and/or drop-off point. For example, many coffee shops, gas stations, restaurants and the like would be interested in sponsoring a carpool originating and/or terminating at their place of business, in return for the potential business from the participants. Of course, the employers and sponsoring businesses do not want to provide incentives without knowing that the parties actually participated in the desired activity. Unfortunately, participation in carpools is notoriously difficult to verify.

Many employees and other individuals would also be interested in participating in carpools, particularly if incentives were provided. Studies indicate that 10%-15% of commuters would like to carpool regularly, and approximately 75% of commuters would like to carpool at least some of the time. However, carpools are very inconvenient to organize and manage. It can be difficult to find compatible parties who live nearby and who are reliable. Once a carpool is organized, parties often have last minute scheduling changes and such that can be hard to accommodate. Additionally, the needs of the 75% of commuters who do not wish to participate in a regular pool, but do have occasional carpooling needs, are particularly difficult to meet.

An automatic commute management system that addressed the difficulties outlined above would be highly desirable.

It would be desirable for the system to create a critical mass of active carpoolers.

### SUMMARY

According to various embodiments of the present invention, methodologies are executed within the context of a shared multi-tenant hosted system to provide commuting management on demand. Multiple organizations (such as companies, universities, municipal governments, physical sites within larger organizations, sponsoring businesses, etc.) can participate across the hosted system. Individual participants can organize car pools and other commuting activity. Organizations can provide incentives to individual participants for engaging in desired activities, such as participating in carpools or otherwise reducing carbon emissions.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter

### BRIEF DESCRIPTION OF THE DRAWINGS

FIG. 1 is a block diagram illustrating a shared multi-tenant hosted system, according to some embodiments of the present invention.

FIG. 2 is a block diagram illustrating a shared multi-tenant hosted system providing incentives for certain activities, according to some embodiments of the present invention.

FIG. 3 is a block diagram illustrating a shared multi-tenant hosted system providing incentives in the form of carbon credits, according to some embodiments of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

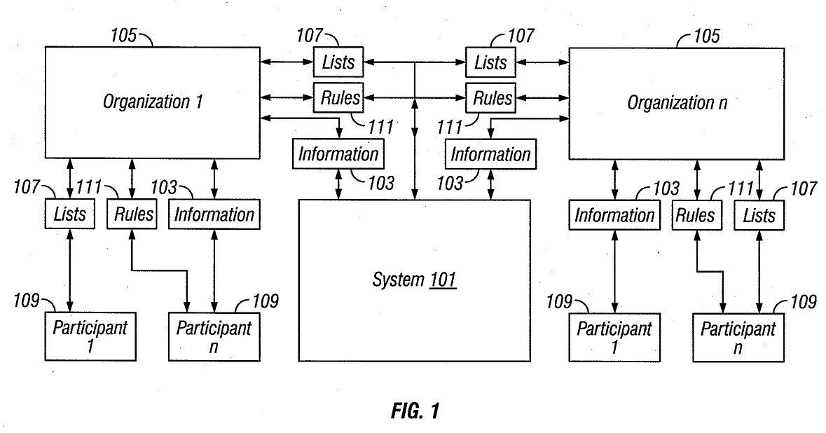

FIG. 1 illustrates a shared multi-tenant hosted system 101 providing commuting management, according to some embodiments of the present invention. It is to be understood that although the shared multi-tenant hosted system 101 is illustrated in FIG. 1 as a single entity, the system 101 represents a collection of functionalities which can be implemented as software, hardware, firmware or any combination of these. Where a component of the system is instantiated as software, it can be implemented as a standalone program, but can also be implemented in other ways, for example as part of a larger program, as a plurality of separate programs, as a kernel loadable module, as one or more device drivers or as one or more statically or dynamically linked libraries.

The system 101 is seeded with information 103 from each participating organization 105, including information 103 concerning each potential participant 109 (e.g., a list of employees at a particular site) and lists 107 of existing carpools within the organization 105. The information 103 concerning the potential participants 109 includes some sort of work and commute point (e.g., home) location information 103, and some form of contact information 103. The commute point location can be in the form of a home address, but can also be in the form of less specific information 103, such as a latitude and longitude, a closest designated pick-up point, a zip code, etc. The contact information 103 can be an email address, one or more phone numbers, an instant message identifier, etc. Additional information 103 can also be included, such as commuting preference information 103 (discussed in detail below).

The information 103 concerning the existing carpools can include such information 103 as the origin and destination of the carpool, the days of the week the carpool runs, times and flexibility, driver rotation policy, preference information 103 of the existing members, etc.

It is to be understood that the specific level of detail and content for both the participant 109 information 103 and the existing carpool information 103 with which to seed the system 101 is a variable design parameter, that can be adjusted as desired. The point is that information 103 that the organization 105 typically already has is fed into the system 101 so that participants 109 can utilize the system 101 automatically, without the need to fill out a lengthy form or otherwise complete an enrollment process that requires proactive steps on their part.

Typically, users 109 who do elect to participate can add to or edit their information 103. For example, Participants 109 can supply additional information 103 to personalize their use of the system 101 (e.g., additional preference information 103), and/or edit existing information 103 as it changes.

The system 101 can also automatically glean publicly available information 103 relevant to commuting. For example, data such as train and bus schedules can be found on web sites, and current traffic information 103 can be read from live electronic feeds. The system 101 can in effect be an integrated on-demand trip planner.

From the seed information 103 and other available information 103, the system 101 automatically constructs lists 107 of rides and other commute options available (e.g., rides going to and from specific pick-up points to specific companies 105, rides going to and from train stations to pick-up points and/or companies 105, rides going from pick-up points to shuttle pick-up locations, etc.). Participants 109 can view available rides, and decide whether they are interested in utilizing any of the commuting options, either on a one time or more frequent basis. As noted above, the potential participants 109 do not need to fill out any forms or take any other proactive steps to browse available options. Additionally, in order to participate they need not declare their intent (e.g., list themselves as wanting a ride from one point to another, or as desiring membership in a carpool with specific criteria), or even login. Instead, they can simply browse lists 107 of available options and join rides, carpools, etc. as desired.

Note that the system 101 shows lists 107 of options to participants 109 based on the level of access that the individual participants 109 have. For example, typically (but not necessarily) participants 109 would have access permission to view all rides hosted by others within their specific organization 105 (i.e., work site). However, organizations 105 can elect to share information 103 with other specific organizations 105, in which case the set of rides available to a given participant 109 would be broader. For example, if two companies 105 that participate in the system 101 are proximately located, they could both elect to share commuting information 103, thereby opening a larger selection of rides and carpools to employees of both companies 105. Of course, organizations 105 can elect not to share information 103 with any other organization 105, or even elect to not share information 103 between segments of the organization 105 (e.g., executives within a company 105 could have a commute list 107 to which non-executives do not have access).

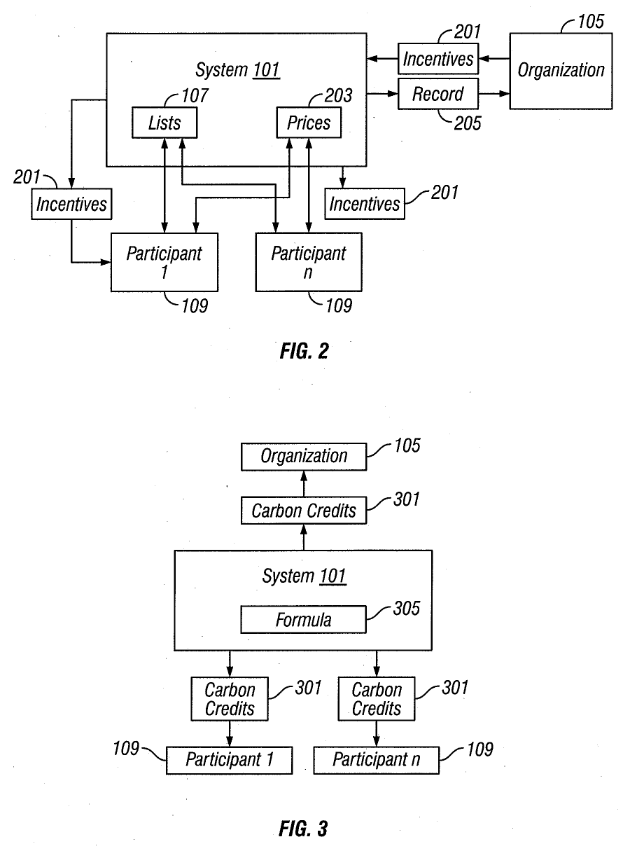

Turning now to FIG. 2, participants 109 view lists 107 of commuting options to which they have access, and can elect to sign up for rides, carpools, etc. In order to encourage participants 109 to provide rides, let new members join carpools, etc., various incentives 201 can be provided. It is to be understood that for tax and other reasons (e.g., reduction of carbon emissions), companies 105 often want their employees to carpool and take public transportation to work. Thus, participating business organizations 105 can purchase a certain amount of virtual currency 201 and distribute it to their employees 109 as a benefit as desired. Thus, potential participants 109 are seeded with currency 201 that they can use to “purchase” rides or join carpools, etc. Drivers 109 and other carpool organizers 109 then receive virtual currency 201 for providing rides or allowing others to participate in or join carpools. In some embodiments, all participants 109 can receive virtual currency 201 for participating in an activity, not just the driver 109 or organizer 109.

Drivers 109 can set the prices 203 for rides to be listed, or the system 101 can determine prices 203 automatically, for example by matching prices 203 to demand. The system 101 can automatically adjust prices 203 in real time, as supply and demand vary or in response to other factors (e.g., incentives 201 provided by an organization 105 to drivers 109 of certain routes, etc.). Drivers and other service providers 109 can also specify some pricing criteria (e.g., a minimum price 203) and allow the system 101 to adjust it according to, for example, market conditions.

The virtual currency 201 (which can be represented, for example, by a point system) is convertible, for example into cash and/or goods and services (e.g., redeemable at local, national or Internet merchants, convertible into other employee benefits, etc.).

Points 201 can be given away, or bought and sold in a “marketplace” that can be as restricted or open as desired. Points 203 can also expire, either partially or entirely, at regular intervals (for example, monthly). Expired points 203 can revert to the originating pool (e.g., the employer 105), and can subsequently be redistributed as desired.

Points 203 can also be used to provide an incentive 201 to login to the system 101. Users 109 can be awarded points 203 for logging in, or become eligible for lower prices 203 and the like once they have logged in. In some embodiments, users 109 are only eligible for some or all incentives 201 (e.g., instant rebates, coupons, carbon credits) once they have logged in.

In some embodiments, sponsors 105 (such as businesses 105 designated as drop-off or pickup points as discussed below) can buy points 203 and distribute them to users 109 (e.g., drivers and/or other carpooling participants 109) in return for participating in a sponsored activity (e.g., a carpool originating from or terminating at the sponsoring business 105). The sponsors 105 can set the criteria for earning and distribution of points 201 as desired (e.g., which users 109 get how many under what circumstances).

This way, the sponsors 105 can provide customized incentives 201 for participating in desired activities (e.g., extra points 201 to first time users 109, frequent users 109, etc.).

Concerning pickup and drop-off locations and other sponsoring businesses 105, these can be businesses 105 such as coffee shops, gas stations, restaurants, strip malls, etc., which are proximately located to the participants 109. Such businesses 105 may wish to sponsor or otherwise subsidize a carpool because being such a location guarantees a certain number of potential customers being present at the site.

Sponsoring businesses 105 can provide coupons 201 and/or instant rebates 201 to participants 109 as desired. For example, a listing 107 of a carpool sponsored by a specific business 105 can have a link or user interface component showing coupons and/or other incentives 201 provided by the sponsor 105 (not illustrated).

Instant rebates 201 can also be provided by employers 105. For example, an employer 105 could sponsor a specific carpool or other activity by paying a certain amount towards the cost to the participant 109. Thus, where participating in a specific carpool as a rider might cost 20 points 201, the employer could provide a five point 201 subsidy, available as a real-time discount only to participants 109 selecting that ride.

Organizations 105 or other parties can also provide additional incentives 201 for desired behavior, such as organizing a carpool, participating in a carpool, taking public transportation, etc. Such incentives 201 can be provided according to factors such as the number of times the activity is conducted, by route, by size of the pool, by length of the commute, etc. Furthermore, the system 101 can provide a verifiable record 205 for employers 105 and sponsors 105 that the rewarded activity actually occurred. Without the present invention, carpools are notoriously hard to verify.

In some embodiments, users 109 can login and utilize the system 101 without their employer 105 actively registering. In such embodiments, the incentives 201 utilized by these users 109 can be provided by their unregistered employers 105 and/or by sponsors 105. An unregistered employer 105 can still purchase virtual currency 201, and distribute same to their employees 109 as desired (e.g., according to a set of rules).

In such embodiments, employees 109 identify themselves in some type of verifiable way, for example by providing their work email address to identify themselves as being associated with their employer 105. In these embodiments, both employees 109 and employers 105 can use the system for free. Employees 109 can receive their virtual currency 201 from employers 105 and/or from sponsoring businesses 105. Employers 105 can still utilize the matching service without providing any virtual currency 201.

It is to be further understood that transaction fees can be charged to an employer or other organization 105 (and/or alternatively to a participant 109) for some, all or none of their executed transactions as desired. In some embodiments, transaction fees are only charged if a party cashes in virtual currency 201, thereby taking it outside of the system 101. This incents parties to keep their points 201 in the system 201, for example by spending them on carpooling activities and the like. In some embodiments, transaction fees are waived for registering parties, thereby encouraging registration, logging in, etc.

Turning now to FIG. 3, one form of real-time incentive 201 that can be provided to participants 109 is carbon credits 301. Those who participate in car pools or take public transportation are reducing carbon-based emissions. The carbon credits 301 received by a participant 109 can be calculated based on factors such as the number of miles carpooled, the number of people in the pool, the fuel efficiency of the vehicles involved, etc. The specific formula 305 to use is a variable design parameter, but in general all participants 109 in a carpool can earn carbon credits 301 based on the calculated emissions reduction associated with their activity. This can optionally include the employer 105 and/or sponsoring organization 105, for example as a percentage of the credits 301 earned by the participants 109 in sponsored activities. The formula (s) 305 to use can be tied, for example, to government regulations concerning such activity. Note that in some embodiments, credits 301 can also be earned for participating in mixed-mode commuting (e.g., taking a carpool to or from a train station, bus stop, etc.) or otherwise using public transportation through the system 101.

Earned carbon credits 301 can be traded and/or sold either externally or within the system 101. In some embodiments, carbon credits 301 can also be used as a form of currency 201 participants 109 can use to bid on/pay for rides and such.

Note that not only might carbon credits 301 have legal standing in the United States in the future (as they do now in other countries), but the reduction of carbon-based emissions in a verifiable way has tremendous personal and public relations-based appeal to many individuals, communities and businesses 105.

Returning to FIG. 1, it is to be understood that the privacy and personal information 103 of all participants 109 can be protected to any desired level of stringency. Users 109 can be identified only be screen names, home addresses would typically never be made available to other users 109, and communication between users 109 can be according to any medium desired (e.g., email, instant message, Skype, phone, fax, etc.) and can still remain private if desired by having the system 101 act as a proxy. Users 109 typically can select different modes of communication for different circumstances.

The system 101 can automatically filter potential rides and other options shown to specific participants 109 based not only on factors such as commute mode (train, bus, shuttle, vanpool, carpool), carpool/ride type (recurring schedule/same-day, one-way/round-trip, etc), or location, but also on preferences specified by one and/or both of the parties matched by a ride. For example, drivers can specify such things as whether or not riders can eat in the car, smoke, stop for errands, bring pets in the vehicle, use cell phones, etc. Riders can specify their needs and preferences, and also such things as whether they can drive if desired. The system 101 can also filter on specific interests of the parties (desire to converse on specific subjects or in specific languages, desire to listen to certain genres of music, desire for silence, etc.).

Parties can rate each other on factors such as reliability and punctuality, and participants 109 can specify what they can and cannot accept in these areas from drivers or riders. The rating need not be subjective or text-based; it can be entirely or partially managed by the system 101 automatically and objectively, such as by automatically keeping track of reliability (number of no-shows, late arrivals) and responsiveness (promptness with which user 109 responds to the requests of other users 109), etc.

As noted above, the system 101 can be seeded with commuting preferences for participants 109 based on what is known by their sponsoring organization 105, and default values can be supplied by the system 101. A participant 109 can also edit his preferences and add new ones.

As participants 109 utilize the system 101, the system 101 will accumulate statistics over time concerning the commuting behavior of the participants 109. The system 101 can make this data available to administrators of the relevant organizations 105 in an easy to view administrative console, displaying summaries of the data as desired. The system 101 can gather and present information 103 such as percentage of employees attempting to carpool, percentage of employees successfully carpooling, carpools per route or point location, etc. This feature can be highly useful to human resource departments and the like.

The system 101 is by no means limited to organizing carpools, one time rides to or from work and public transportation. The system 101 can also be used to arrange for rides to and from lunch at restaurants near an organization 105 (such rides can be sponsored or subsidized by the restaurants), rides to conferences, rides to sporting or entertainment events, etc. Commercial cab operators can provide availability information 103 to the system 101, and riders can arrange for shared cabs on a fee sharing basis. Mixed mode rides can be organized, where riders combine public transportation with carpooling, for example riding from a pick-up location to a public transportation hub, or from a train or bus stop to work. The system 101 can coordinate company shuttles, e.g., by keeping track of how many seats are free on a shuttle in real time and/or only sending a shuttle to a pick-up point when a requisite number of riders have requested use of the shuttle, thereby eliminating costly under-used routes or times, etc.

The system 101 can also pool riders and such, so that a driver is only informed once a requisite condition has occurred, such as two riders having requested transportation over a route or bridge the carpool lane of which requires three people in a car. The system 101 can also account for tolls, the cost of gasoline, mileage cost, etc., dividing these expenses among the participants 109 or charging them to riders as requested by the driver and agreed to by the participants 109, etc.

In addition to scheduling transportation, rides and new carpool activity, the system 101 can also manage existing carpool activity. If a carpool participant 109 needs to communicate with the pool (e.g., he cannot make it on a certain day, needs to change a time, etc.), rather than a series of phone calls or emails, the participants 109 can communicate with each other through the system 101, using the specified communicate preferences.

Information 103 concerning participants 109 can also include default and/or user 109 supplied or edited rules 111, for actions to take in certain situations. For example, a rule 111 can specify that if a user 109 missed a ride, the system 101 is to find an alternative ride meeting certain criteria, or if a carpool is missing a member on a given day, to post a listing for a replacement rider, etc. Rules 111 can specify that the system 101 contact a participant 109, e.g., by cell phone or email when a ride is cancelled, or postponed, etc.

To join a ride or carpool, a user 109 can commit to a listed ride viewable to the user 109, or the user 109 can express non-committal interest in one or more options. The system 101 communicates such expressions of interest to the relevant parties, which can accept or reject the offer, or make a counter proposal, which can result in negotiation (e.g., over price 203 and/or other terms). Such communication is conducted via the participant 109's specified choices, which can include a messenger program provided by the system 101, email, etc.

Through the process of ongoing operation, the system 101 will accumulate a great deal of data regarding commuting patterns, which it can use to self learn and improve its scheduling and operations activity, or for other purposes as well. The system 101 can also self adjust the incentives 201 offered, based on real time market conditions (e.g., incentives 201 can be adjusted to encourage more riders, more drivers, participants 109 on certain routes or at certain times, etc.). Employers 105 can also tweak incentives 201 as desired.

Note that the system 101 does not even require users 109 to login, unless they are participating in certain activities that require user 109 identification (e.g., to communicate with other users 109 through the system 101, to join a ride, to change a carpool ride schedule, to purchase/redeem points, etc.). It is possible for a user 109 to do many things without logging in, for example to browse the system 101 with different search parameters, to view custom results (e.g., by typing in all or a part of an address), to view details of a resulting match, etc.).

As noted above, the system 101 can be used to market alternate transportation modes and various commuter benefits to employees. The system 101 can lower the barrier to usage of alternate modes of transportation, for example by giving solo drivers an incentive 201 and opportunity to provide rides to others with the absolute minimum amount of inconvenience or discomfort.

Users 109 can learn of other proximately domiciled users 109 (neighbors) and send them messages, inviting them to rideshare on a one-time or regular basis. Users 109 who live in close proximity can communicate for other purposes as well, for example to organize a party.

Another provided mechanism is the ability of users 109 who are active on the system 101 to communicate with other users 109 who are not, and negotiate deals to acquire their points.

The system 101 can be used by an employer 105 to communicate with employees in a targeted, non-intrusive way, including anonymously. This type of communication can be two way, allowing employees to have real-time dialog with management, anonymously where desired.

It will be readily apparent to those of ordinary skill in the relevant art that the above described system 101 and methodologies can be utilized in other contexts as well. In other embodiments, the system 101 can be used to schedule and manage other activities, such as delivery routing, courier dispatching, pizza delivery, one time pick-up and delivery of movable property, local shopping, etc. The system 101 can also be used, for example, for secure, private, anonymous and targeted real time buying and selling or other forms of commerce, as well as for arranging social meetings (including dating) among group members. The system 101 can be used to route traffic through incentives 201 to and communications with commuters. The system 101 can be used to arrange for designated drivers (for example, a bar 105 could provide the system 101 as a service to customers 109). Furthermore, the system 101 can be used by parents for forming a group to rotate pick-up and drop-off responsibilities for their children. Although users 109 can operate the system 101 via a user interface on a computing device, other interface mediums are also possible, such as wired or wireless electronic voice or digital control, handheld devices, etc.

Appendices 1-42 show screen shots of the operation of certain features of the system 101, according to some embodiments of the invention. These appendices depict embodiments of the present invention for purposes of illustration only. One skilled in the art will readily recognize from the above discussion that alternative embodiments of the structures and methods illustrated herein may be employed without departing from the principles of the invention described herein.

As will be understood by those familiar with the art, the invention may be embodied in other specific forms without departing from the spirit or essential characteristics thereof. Likewise, the particular naming and division of the modules, agents, managers, functions, procedures, actions, layers, features, attributes, methodologies and other aspects are not mandatory or significant, and the mechanisms that implement the invention or its features may have different names, divisions and/or formats. Furthermore, as will be apparent to one of ordinary skill in the relevant art, the modules, agents, managers, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Furthermore, it is to be understood that where functionality is described as being performed by an employer, other types of organizations can typically perform the same functionality as well. Accordingly, the disclosure of the present invention is intended to be illustrative, but not limiting, of the scope of the invention, which is set forth in the following claims.

What is claimed is:

1. A computer implemented method for providing commuting management on demand, the method comprising the steps of:
receiving commuting related information from at least one organization;
allowing a plurality of participants associated with the at least one organization to organize and engage in commuting related activity by using the information; and
providing at least one incentive to at least one participant for engaging in at least one commuting related activity.
